(19) United States
(12) Patent Application Publication
(10) Pub. No.: US 2007/0120794 A1
(43) Pub. Date: May 31, 2007

(54) Driving apparatus for display device

(75) Inventors: Byung-Hyuk Shin, Seoul (KR); Jae-Hyoung Park, Yongin-si (KR); Woo-Chul Kim, Uijeongbu-si (KR); Byung-Kil Jeon, Anyang-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/604,110

(22) Filed: Nov. 22, 2006

(30) Foreign Application Priority Data
Nov. 25, 2005 (KR) 10-2005-0113335

(51) Int. Cl. G09G 3/36

(52) U.S. Cl. 345/89

(57) ABSTRACT

Driving apparatus for a display panel having a plurality of pixels includes a plurality of gate line sets connected to the pixels and transmitting a gate-on voltage to the pixels, a plurality of data lines connected to the pixels and transmitting a normal data voltage and an impulsive data voltage to the pixels, a signal controller for converting an input image data of a first gray to an output image data of a second gray and outputting the converted data, a data driver connected to the data line and applying the normal data voltage and the impulsive data voltage corresponding to the output image data to the data line, and a gate driver connected to the gate line and applying the gate-on voltage to the gate line according to a control of the signal controller. The normal data voltage is sequentially applied to a first gate line set among the plurality of gate line sets, and the impulsive data voltage is sequentially applied to a second gate line set among the plurality of gate line sets. The output image data of the second gray is determined in consideration of luminance display time of a pixel charged by the normal data voltage. Accordingly, luminance deterioration by different luminance display times for respective pixel rows connected to respective gate lines in the gate line set can be prevented.

### CROSS-REFERENCE TO RELATED APPLICATION

This application claims priority to and the benefit of Korean Patent Application No. 10-2005-0113335 filed in the Korean Intellectual Property Office on Nov. 25, 2005, the contents of which are incorporated herein by reference.

### FIELD OF THE INVENTION

The present invention relates to a driving apparatus forr a display device.

### DESCRIPTION OF THE RELATED ART

Generally, a liquid crystal display (LCD) includes two panels, one provided with pixel electrodes disposed in a matrix shape and connected to switching elements such as thin film transistors (TFTs) while the other is provided with a common electrode. A liquid crystal layer having dielectric anisotropy is disposed between the panels. In terms of an equivalent circuit, a pixel electrode, the common electrode, and the liquid crystal layer form a liquid crystal capacitor. Data voltages applied to the electrodes form an electric field in the liquid crystal layer which varies the transmittance of light passing through the liquid crystal layer so as to display an image. In order to prevent degradation caused by long-term application of an electric field in one direction to the liquid crystal layer, the polarity of the data voltage with respect to the common voltage is inverted each frame, row, or pixel.

However, when the polarity of the data voltage is reversed, there may not be enough time to fully charge the liquid crystal capacitor to the target voltage. This may cause images to be blurred. In order to solve this problem, resort has been made to an impulsive driving method which presents a black view for a short time. Impulsive driving methods may be divided into an impulsive emission type wherein a backlight lamp is periodically turned off so as to make the entire screen black, and a cyclic resetting type wherein an impulsive data voltage such as a black data voltage is periodically applied in addition to a normal data voltage that is primarily concerned with displaying images.

However, since these methods cannot compensate for the slow response speed of liquid crystal or the slow reaction speed of the backlight lamp, the picture quality suffers from afterimage or flicker. Further, the method of applying an impulsive data voltage decreases the time available for applying the normal data voltage. In addition, if impulsive driving is performed by simultaneously applying the impulsive data voltage to a group of neighboring gate lines, the interval between the normal data voltage and the impulsive data voltage applied to the group of gate lines is not constant for all of the gate lines resulting in pixels having differing luminance. Accordingly, horizontal stripes may occur thereby degrading picture quality.

### SUMMARY OF THE INVENTION

An exemplary embodiment of the present invention provides an impulsive driving apparatus for a display panel including a plurality of gate line sets connected to pixels and transmitting a gate-on voltage to the pixels, a plurality of data lines connected to the pixels and transmitting a normal data voltage and an impulsive data voltage thereto, a signal controller for converting input image data of a first gray level to output image data of a second gray level and outputting the converted data, a data driver connected to the data lines and applying the normal data voltage and the impulsive data voltage corresponding to the output image data to the data lines, and a gate driver connected to the gate lines and applying the gate-on voltage to the gate line sets under control of the signal controller. The normal data voltage is sequentially applied to a first gate line set among the plurality of gate line sets, and the impulsive data voltage is sequentially applied to a second gate line set among the plurality of gate line sets.

The input image data may have a first number of bits, and the signal controller may add weighted image data of a second number of bits to the input image data of the first number of bits so as to convert the input image data to compensated image data of a third number of bits.

The signal controller may output the compensated image data as the output image data if the number of bits of the output image data is equal to the number of bits of the compensated image data.

If the number of bits of the output image data is different from the number of bits of the compensated image data, the signal controller may store a plurality of dithering data patterns including data elements having a first value or a second value, it may select a dithering data pattern corresponding to the compensated image data of the second number of bits among the plurality of dithering data patterns, it may convert the compensated image signal to the output image signal of a fourth number of bits that is less than the third number of bits on the basis of the selected dithering data pattern, and it may output the converted signal.

The signal controller may include a first lookup table for storing a plurality of dithering data patterns, and a data processor for converting the compensated image data on the basis of the plurality of dithering data patterns stored in the first lookup table.

The data processor may include a bit number expanding member for expanding the input image data of the first number of bits to the input image data of the third number of bits, an adder for adding the input image data of the third number of bits and the weighted image data of the second number of bits so as to generate the compensated image data of the third number of bits, and a dithering controller for converting the compensated image data of the third number of bits to the output image data of the fourth number of bits.

The data processor may include: a second lookup table for storing a plurality if compensated image data of the third number of bits as a function of the input image data of the first number of bits and a line number of a first gate line set, and for selecting the compensated image data of the third number of bits corresponding to the input image data and the line number and outputting the selected data; and a dithering controller for converting the compensated image data of the third number of bits to the output image data of the fourth number of bits.

The data processor may include a bit number expanding member for expanding the input image data of the first number of bits to the input image data of the third number of bits; a second lookup table for storing a plurality of weighted image data of the second number of bits corresponding to respective line numbers of a first gate line set, and selecting the weighted image data of the second number of bits corresponding to a line number of the first gate line set and outputting the selected data; an adder for adding the input image data of the third number of bits and the weighted image data of the second number of bits so as to generate the compensated image data of the third number of bits; and a dithering controller for converting the compensated image data of the third number of bits to the output image data of the fourth number of bits.

A difference between the third number of bits and the fourth number of bits may be three.

The dithering data pattern corresponding to the compensated image data among the plurality of dithering data patterns may be determined on the basis of the three lower bits of the compensated image signal and a frame number.

The signal processor may determine upper bits excluding the lower three bits as a data value of the output image data, if a value of the lower three bits of the compensated image data is 000.

The second gray may be equal to or greater than the first gray.

The frequency of the input image data may be different from the frequency of the output image data.

The frequency of the input image data may be less than the frequency of the output image data.

The gate-on voltage may include a first gate-on voltage for applying the normal data voltage and a second gate-on voltage for applying the impulsive data voltage.

The periods of applying the first and second gate-on voltages may be equal to each other. The applying periods of the first and second gate-on voltages may be shorter than 1 H. The impulsive data voltage may be less than the normal data voltage. The impulsive data voltage may be a black data voltage.

### BRIEF DESCRIPTION OF THE DRAWINGS

The foregoing and other objects and features of the present invention may become more apparent from the ensuing description when read together with the drawing, in which:

FIG. 1 is a block diagram of a liquid crystal display according to an exemplary embodiment of the present invention.

FIG. 2 is an equivalent circuit diagram of one pixel of a liquid crystal display according to an exemplary embodiment of the present invention.

FIG. 3 is a waveform diagram of scanning start signals and gate signals used in a liquid crystal display according to an exemplary embodiment of the present invention.

FIG. 4 shows a set of dithering data patterns according to an exemplary embodiment of the present invention.

FIG. 5A to FIG. 5C are examples of a block diagram of a signal processor of a signal controller of a liquid crystal display according to an exemplary embodiment of the present invention.

### DETAILED DESCRIPTION OF THE EMBODIMENTS

The present invention will now be described more fully hereinafter with reference to the accompanying drawings, in which preferred embodiments of the invention are shown.

In the drawings, the thickness of layers, films, panels, regions, etc . . . , are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

A driving apparatus of a liquid crystal display, which is an exemplary embodiment of a driving apparatus of a display device according to the present invention, will be explained in detail with reference to the accompanying drawings.

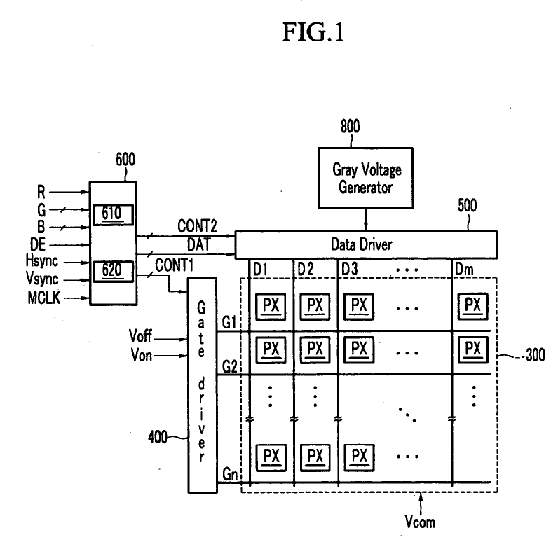

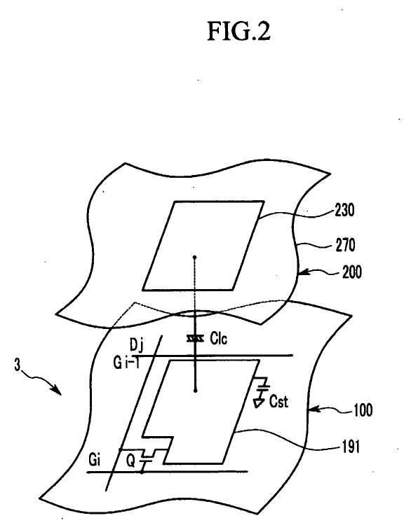

First, referring to FIG. 1 and FIG. 2, a liquid crystal display according to an exemplary embodiment of the present invention will be explained in detail.

FIG. 1 is a block diagram of a liquid crystal display according to an exemplary embodiment of the present invention, and FIG. 2 is an equivalent circuit diagram of one pixel of a liquid crystal display according to an exemplary embodiment of the present invention.

As shown in FIG. 1, a liquid crystal display according to an exemplary embodiment of the present invention includes a liquid crystal panel assembly 300, a gate driver 400 and a data driver 500 connected to the liquid crystal panel assembly 300, a gray voltage generator 800 connected to data driver 500, and a signal controller 600 controlling these members.

The liquid crystal panel assembly 300 includes aplurality of signal lines G₁ to Gₙ and D₁ to Dₘ, and a plurality of pixels PX connected to the signal lines and substantially arranged in a matrix shape. Meanwhile, in a structure shown in FIG. 2, the liquid crystal panel assembly 300 includes lower and upper panels 100 and 200 that face each other, and a liquid crystal layer 3 interposed therebetween.

The signal lines G₁ to Gₙ and D₁ to Dₘ include a plurality of gate lines G₁ to Gₙ that transmit gate signals (also referred to as “scanning signals”), and a plurality of data lines D₁ to Dₘ that transmit data signals. The gate lines G₁ to Gₙ substantially extend in a row direction to be parallel to one another, and the data lines D₁ to Dₘ substantially extend in a column direction to be parallel to one another.

Each pixel PX, for example the pixel PX connected to the i-th (i=1, 2, . . . , n) gate line Gᵢ and the j-th (j=1, 2, . . . , m) data line Dⱼ, includes a switching element Q connected to the signal lines Gᵢ and Dⱼ and a liquid crystal capacitor Clc and a storage capacitor Cst connected to the switching element Q. If necessary, the storage capacitor Cst can be omitted.

The switching element Q is a three terminal element such as a thin film transistor, etc., provided to the lower panel 100, and a control terminal thereof is connected to the gate line Gᵢ, an input terminal thereof is connected to the data line Dⱼ, and an output terminal thereof is connected to the liquid crystal capacitor Clc and the storage capacitor Cst.

The liquid crystal capacitor Clc has two terminals of a pixel electrode 191 of the lower panel 100 and a common electrode 270 of the upper panel 200. The liquid crystal layer 3 between the two electrodes 191 and 270 serves as a dielectric material. The pixel electrode 191 is connected to the switching element Q, and the common electrode 270 is formed on the entire surface of the upper panel 200. A common voltage Vcom is applied to the common electrode 270. Unlike FIG. 2, the common electrode 270 may be provided on the lower panel 100. In this case, at least one of the two electrodes 191 and 270 can be formed in a linear or bar shape.

The storage capacitor Cst, which assists the liquid crystal capacitor Clc, includes a separate signal line (not shown) and the pixel electrode 191 provided on the lower panel 100 to overlap each other with an insulator interposed therebetween. A fixed voltage such as the common voltage Vcom is applied to the separate signal line. However, the storage capacitor Cst may be formed by the pixel electrode 191 and the overlying previous gate line arranged to overlap each other through the insulator.

In a color display, each pixel PX uniquely displays one of primary colors (spatial division) or each pixel PX alternately displays primary colors over time (temporal division) so that a desired color is recognized by the spatial and temporal sum of the primary colors. Examples of the primary colors include three primary colors including red, green, and blue. FIG. 2 shows an example of the spatial division. In this example, each pixel PX has a color filter 230 for one of the primary colors in a region of the upper panel 200 corresponding to the pixel electrode 191. Unlike FIG. 2, color filter 230 may be formed above or below pixel electrode 191 of lower panel 100.

At least one polarizer (not shown) for polarizing light is attached to an outer surface of the liquid crystal panel assembly 300.

Referring again to FIG. 1, gray voltage generator 800 generates two sets of gray voltages (a set of reference gray voltages) related to the transmittance of the pixels PX. The two sets of gray voltages have a positive value and a negative value with respect to the common voltage Vcom, respectively.

Gate driver 400 is connected to gate lines G₁ to Gₙ of the liquid crystal panel assembly 300, and applies the gate signals, which are combinations of a gate-on voltage Von and a gate-off voltage Voff, to gate lines G₁ to Gₙ.

Data driver 500 is connected to data lines D₁ to Dₘ of the liquid crystal panel assembly 300. Data driver 500 selects one of the gray voltages from gray voltage generator 800, and applies the selected gray voltage to the data lines D₁ to Dₘ as a data signal (a data voltage). However, when gray voltage generator 800 supplies the reference gray voltages of a predetermined number, rather than voltages for all gray levels, data driver 500 divides the reference gray voltages so as to generate the gray voltages for all gray levels and selects the data voltage from among these.

Signal controller 600 includes a data processor 610 and a lookup table 620, and controls gate driver 400 and data driver 500, etc.

Data processor 610 converts a P-bit input image signal input to signal controller 600 into (P+Q)-bit compensated image data, and then performs a dithering control. If the number of bits that can be processed by data driver 500 is less than the number of bits of the input image date, i.e., the compensated image data, the dithering control reconstructs image data formed by taking upper bits corresponding to the number of bits that can be processed by data driver 500 among the bits of the compensated image data based on lower bits in a frame unit. That is, only the upper bits (P-bits) corresponding to the number of bits that can be processed by data driver 500 among bits ((P+Q)-bits) of the compensated image data compensated in the data processor 610 are selected. The data indicated by the remaining lower bits (Q-bits) is realized by temporal and spatial averages of these upper bits.

Lookup table 620 stores compensation values of image data, which are necessary for the dithering control, with respect to respective pixels depending on values of the lower bits. A set of compensated values corresponding to a basic pixel unit of the dithering control is referred to as a dithering data pattern.

Each of drivers 400, 500, 600, and 800 may be directly mounted on the liquid crystal panel assembly 300 in a form of at least one IC chip, may be attached to the liquid crystal panel assembly 300 while being mounted on a flexible printed circuit film (not shown) by a TCP (tape carrier package), or may be mounted on a separate printed circuit board (not shown). Alternatively, drivers 400, 500, 600, or 800 may be integrated into the liquid crystal panel assembly 300, together with the signal lines G₁ to Gₙ and D₁ to Dₘ and the thin film transistor switching elements Q. In addition, drivers 400, 500, 600, or 800 may be integrated into a single chip. In this case, at least one of them or at least one circuit element constituting them may be outside the single chip.

The display operation of the liquid crystal display will now be described in detail.

Signal controller 600 receives input image signals R, G, and B and input control signals for controlling the display of the input image signals R, G, and B. The input image signals R, G, and B contain information of luminance of each pixel PX, and the luminance has grays of a predetermined number, for example 1024 (□2¹⁰), 256 (□2⁸) or 64 (□2⁶). Examples of the input control signals include a vertical synchronization signal Vsync, a horizontal synchronizing signal Hsync, a main clock signal MCLK, a data enable signal DE, etc.

Signal controller 600 processes the input image signals R, G, and B according to the operating conditions of the liquid crystal panel assembly 300 on the basis of the input image signals R, G, and B and the input control signals, and generates a gate control signal CONT1 and a data control signal CONT2. Then, signal controller 600 supplies the gate control signal CONT1 to gate driver 400 and supplies the data control signal CONT2 and the processed image signal DAT to data driver 500.

Data processing by signal controller 600 includes the dithering control of the signal processor 610 using the dithering data pattern stored in lookup table 620. If the number of bits of the input image signals R, G, and B is eight, the total number of bits of the compensated image signal compensated by the signal processor 610 is eleven and the number of bits that can be processed by data driver 500 is eight, and signal controller 600 compensates data of the eight upper bits on the basis of the dithering data pattern stored in the lookup table 620 according to data values of the three lower bits, and then outputs the compensated signal as the output image signal DAT.

In addition, the data processing of signal controller 600 may also include applying impulsive image data in addition to applying normal image data based on the input image signals R, G, and B. For this, signal controller 600 converts input image signals R, G, and B of M (M is a natural number) pixel rows into normal image data of pixel rows, and normally applies the converted normal image data to M pixel rows. Signal controller 600 generates impulsive image data, and simultaneously applies the impulsive image data to M different pixel rows for substantially the same time as a time while each normal image data is applied. At this time, since M impulsive image data are simultaneously applied, the time for applying M normal image data and M impulsive image data is equal to the time for applying (M+1) normal image data. The impulsive image data may be a black gray or may show an arbitrary constant luminance.

Accordingly, the frequency of the horizontal synchronization start signal STH is (M+1)/M times a frequency of the horizontal synchronizing signal Hsync. In addition, the frequency of the data clock signal HCLK to which the output image signal DAT is synchronized may be (M+1)/M times the frequency of the main clock signal MCLK to which the input image signals R, G, and B are synchronized. Examples of M include 6.

Accordingly, the output image signal DAT is a digital signal and has one of a predetermined number of values (or grays). The output image signal DAT includes normal image data formed by performing dithering control of the compensated image data and the impulsive image data for impulsive driving.

Data processing of signal controller 600 will now be explained in detail.

The gate control signal CONT1 may include a scanning start signal STV that instructs to start scanning, a gate clock signal CPV for controlling an output timing of a gate-on voltage Von, an output enable signal OE for limiting a duration time of the gate-on voltage Von, and so on.

The data control signal CONT2 includes a horizontal synchronization start signal STH that notifies transmission of output image signal DAT to one row of pixels PX, a load signal LOAD for instructing to apply the data signal to the data lines D₁ to Dₘ, and a data clock signal HCLK. The data control signal CONT2 may also further include an inversion signal RVS for inverting the voltage polarity of the data signal relative to the common voltage Vcom (hereinafter, the voltage polarity of the data signal relative to the common voltage is simply referred to as the polarity of the data signal).

On the basis of the data control signal CONT2 from signal controller 600, data driver 500 receives output image signals DAT for one row of pixels PX, and selects the gray voltages corresponding to output image signals DAT, respectively. Then, data driver 500 coverts the output image signals DAT into the analog data signals, and applies the analog data signals to the data lines D₁ to Dₘ. The analog data signal includes a normal data voltage corresponding to normal image data and an impulsive data voltage corresponding to impulsive image data. The impulsive data voltage may be a black data voltage.

Gate driver 400 applies the gate-on voltage Von to the gate lines Gᵢ to Gₙ on the basis of the gate control signal CONT1 from signal controller 600 so as to turn on the switching elements Q connected to the gate lines G₁ to Gₙ. Accordingly, the data signal applied to the data lines D₁ to Dₘ is applied to the corresponding pixel PX through the turned-on switching element Q.

A difference between the voltage of the data signal applied to the pixel PX and the common voltage Vcom becomes a charge voltage of the liquid crystal capacitor Clc, that is, a pixel voltage. The alignment of liquid crystal molecules varies according to the value of the pixel voltage, and thus the polarization of light passing through the liquid crystal layer 3 is changed. The change in polarization causes a change in transmittance of light by polarizers attached to the display panel assembly 300.

By repeating this operation for every one input horizontal period (referred to as “1H” and that is equal to one cycle of the horizontal synchronizing signal Hsync), the gate-on voltage Von is sequentially applied to all of the gate lines G₁ to Gₙ and the normal image data voltage and the impulsive data voltage are applied to all of the pixels PX, so that a normal image and an impulsive image corresponding to one frame are displayed once for one frame.

If one frame is completed and a next frame starts, the state of the inversion signal RVS to be applied to data driver 500 is controlled such that the polarity of the data voltage to be applied to each pixel is opposite to the polarity in the previous frame (“frame inversion”). At this time, the polarity of the normal image data voltage on one data line may be changed in one frame according to the characteristics of the inversion signal RVS (for example, row inversion or dot inversion), or the normal image data voltages applied to rows of pixels may be different from each other (for example, column inversion or dot inversion). The polarity of the impulsive data voltage may be changed according to the inversion signal RVS, or may be an arbitrary polarity.

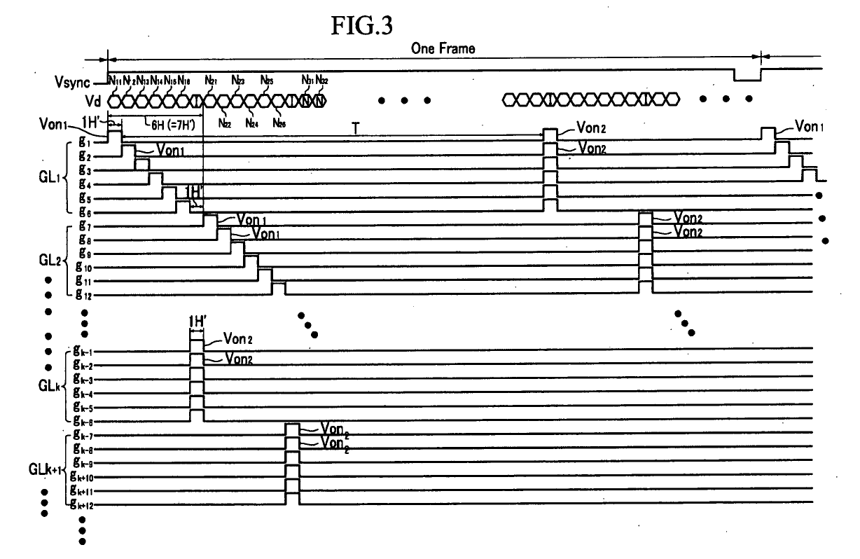

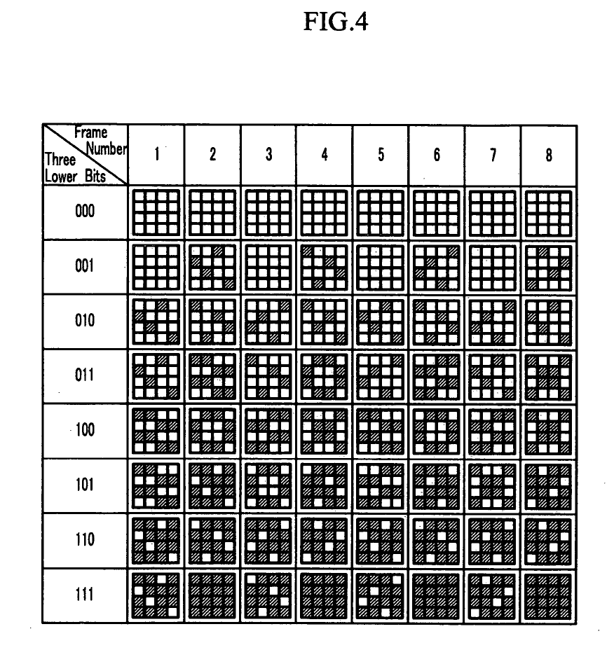

Data processing of a liquid crystal display according to an exemplary embodiment of the present invention will now be explained in more detail with reference to FIG. 3 and FIG. 4.

First, impulsive driving will be explained with reference to FIG. 3.

FIG.3 is a waveform diagram of various signals used in a liquid crystal display according to an exemplary embodiment of the present invention, and shows the vertical synchronization signal Vsync, the data voltage Vd, and the gate signals g1, g2, . . . , etc.

As described above, the data voltage Vd includes normal data voltages N₁₁ to N₁₆, N₂₁, . . . corresponding to the normal image data and an impulsive data voltage I corresponding to the impulsive image data. The normal data voltages N₁₁ to N₁₆, N₂₁, . . . are sequentially applied in a unit of the predetermined number of pixel rows, for example six, and then the impulsive data voltages I are simultaneously applied to six other pixel rows. Accordingly, during 6H, six normal data voltages N₁₁ to N₁₆, N₂₁, . . . and six impulsive data voltages I are applied to the corresponding data lines D₁ to Dₘ. For example, an inversion method of the data voltage Vd is 1 dot inversion or row inversion.

As shown in FIG. 3, the gate-on voltage Von applied to respective gate signals g1, g2, . . . includes a first gate-on voltage Von1 for applying the normal data voltages N₁₁ to N₁₆, N₂₁, . . . and a second gate-on voltage Von2 for applying the impulsive data voltage I. As shown in FIG. 3, an output time of the first gate-on voltage Von1 and an output time of the second gate-on voltage Von2 are equal to each other, but they may be different from each other. At this time, the output time of the gate-on voltages Von1 and Von2 is referred to as 1 output horizontal period 1H′, and is equal to one cycle of the data clock signal HCLK.

Impulsive driving will now be explained. If one frame is started according to the vertical synchronization signal Vsync, the first gate-on voltage Von1 is applied to gate signals g₁ to g₆ that are sequentially applied to the first gate line G₁ to the sixth gate line G₆. Accordingly, for each 1H′ while the first gate-on voltage Von1 is output, respective pixels connected to the first gate line G₁ to the sixth gate line G₆ are sequentially charged by their normal data voltages N₁₁ to N₁₆.

As such, if the corresponding normal data voltages N₁₁ to N₁₆ are charged to six consecutive pixel rows, the second gate-on voltage Von2 is simultaneously applied to the (k+1)-th gate line Gₖ₊₁ to the (K+6)-th gate line G_{K+6}, and pixels connected to the (k+1)-th gate line Gₖ₊1 to the (K+6)-th gate line G_{K+6} are charged by the impulsive data voltage I for the next 1H′.

Subsequently, the first gate-on voltage Von1 is sequentially applied to the gate signals g₇ to g₁₂ applied to the seventh gate line G₇ to the twelfth gate line G₁₂, so that respective pixels connected to the corresponding gate lines G₇ to G₁₂ are sequentially charged by their normal data voltages N₂₁ to N₂₆. Subsequently, the second gate-on voltage Von2 is simultaneously applied to the gate signals gₖ₊₇ to gₖ₊₁₂ applied to the (k+7)-th gate line Gₖ₊₇ to the (K+12)-th gate line G_{K+12}, and respective pixels connected to the (k+7)-th gate line Gₖ₊₇ to the (K+12)-th gate line Gₖ₊₁₂ are charged with the impulsive data voltage I.

As such, the gate lines G₁ to Gₙ are divided into a plurality of gate line sets GL1, GL2, . . . that are respectively formed with six gate lines G₁ to G₆, G₇ to G₁₂, . . . , normal data voltages N₁₁ to N₁₆, N₂₁ to N₂₆, . . . are applied to the first gate line set GL1 to the final gate line set while maintaining an interval of 1 H′ between neighboring gate line sets, and during 1 H′ while the normal data voltages N₁₁ to N₁₆, N₂₁ to N₂₆, . . . are not applied after the normal data voltages N₁₁ to N₁₆, N₂₁ to N₂₆, . . . are applied to the respective gate line sets GL1, GL2, . . . , the impulsive data voltage I is sequentially applied to the K-th gate line group GLₖ to the (K−1)-th gate line group GL_{k-1 in every interval of} 6 H′.

Accordingly, impulsive image bands having a width of six pixel rows are sequentially displayed in a direction from the upper portion of a screen to the lower portion of a screen, so that the impulsive driving is performed.

At this time, the normal data voltages N₁₁ to N₁₆, N₂₁ to N₂₆, . . . that are applied to respective gate lines G₁ to Gₙ are data voltages calculated by adding a weight value to a data voltage determined on the basis of the input image signals R, G, and B.

That is, in respective gate line sets, a gate-on voltage interval T between the outputting of the first gate-on voltage Von1 and the outputting of the second gate-on voltage Von2 is longest in the first gate line among six gate lines, and is shortest in the final sixth gate line among six gate lines. As such, as a number of the gate line increases, the gate-on voltage interval T decreases, so that a time during which the corresponding luminance is displayed by being charged with the normal data voltage decreases as a number of the gate line increases. Accordingly, the amount of loss of luminance is different for respective gate lines. If the number of the gate line of the gate line set is six and the data voltage of the equivalent gray is applied to the corresponding pixel, a luminance loss of about 1 gray additionally occurs in the sixth and final gate line compared to in the first gate line by the decreased luminance display time.

In addition, charging conditions of a pixel that is connected to the first gate line that is charged to a gray corresponding to its own normal data voltage from a gray corresponding to the impulsive data voltage I, for example a black gray for the same charging time 1 H′, and charging conditions of pixels connected to the other gate lines that are charged to a gray corresponding to their own normal data voltages from a gray corresponding to the normal data voltage of the previous pixel row, are different from each other. By the difference of the charging conditions, a luminance difference between the pixel row of the first gate line and the pixel rows of the other five gate lines occurs.

Accordingly, different weight values are allotted to the corresponding image data in consideration of the gate-on voltage intervals T and charging conditions that are different from each other for respective gate lines of the gate line set, so that the gray determined by the input image signals R, G, and B is changed. That is, as the gate-on voltage interval T is short, the weight value is increased, so that an amount of luminance decreased by the decreased luminance display time is compensated.

For this, the signal processor 610 of signal controller 600 adds a three-bit weight value (weighted image data) to eight-bit input image data as lower bits so as to expand the eight-bit image data to eleven-bit image data, thereby generating the compensated image data by compensating the image signal by dividing one gray into 8 (=2³) steps. Accordingly, the eleven-bit compensated image data has a gray value that is increased by the value of the three added bits so as to compensate an amount of the decreased luminance. At this time, the value of the three-bit weight image data added for respective lines is predetermined on the basis of gate-on voltage intervals that are different for respective lines, i.e., different luminance display times. For example, the weighted image data for a first gate line may be “001”, the weighted image data for a second gate line may be “010”, the weighted image data for a third gate line may be “011”, the weighted image data for a fourth gate line may be “100”, the weighted image data for a fifth gate line may be “101”, and the weighted image data for a last sixth gate line may be “111”.

At this time, the number of a bit of the three-bit weighted image data can be varied in consideration of a gray difference between the gate line sets. By increasing the number of a bit of the weighted image data, the gray value of one gray can be subdivided or the gray value can be changed to one gray unit. For example, if the weighted image data is four bits, the lower three bits of the weighted image data can be added to the lower three bits of the image data, and the other one bit of the weighted image data can be added to an upper bit of the image data.

Although the eight-bit image signal is expanded to the eleven-bit image signal by the signal processor 610 of signal controller 600, the number of bits that can be processed by data driver 500 is eight. Therefore, the signal processor 610 performs dithering control to the eleven-bit compensated image data using the dithering data pattern stored in the lookup table 620, and applies the eight-bit output image data DAT to data driver 500.

Meanwhile, if the number of bits that can be processed by data driver 500 is eleven, i.e., if the number of bits of the compensated image data generated by the signal processor 610 is equal to the number of bits that can be processed by the data driver 600, the image data can be transmitted to data driver 500 as the output image data DAT without separate signal processing such as the dithering control. In this case, the lookup table 620 for storing the dithering data pattern is not needed.

The dithering control performed by the signal processor 610 of signal controller 600 will now be explained with reference to FIG. 4.

FIG. 4 shows an example of the dithering data pattern according to an exemplary embodiment of the present invention.

The dithering data pattern as shown in FIG. 4 is stored in the lookup table 620 of signal controller 600, and respective dithering data patterns included in the dithering data pattern set are determined depending on values of lower three bits of the compensated image data and the frame number. There are a total of sixty-four dithering data patterns with respect to eight continuous frames and to values of 000, 001, 010, 011, 100, 101, 110, and 111 of the lower three bits. When the value of the lower three bits is 000, the data pattern may not be particularly determined. In this case, a total of fifty-six dithering data patterns excluding eight dithering data patterns may be stored in the lookup table 620.

As shown in FIG. 4, the basic unit of a spatial disposition in respective dithering data patterns is a 4×4 data matrix, and the dithering data pattern is repeatedly applied with a basic unit of 4×4 pixel matrix corresponding to the same. Data elements of respective dithering data patterns have a value of “1” or “0”. In the drawing, the data element having the value of “0” are shown in a white color, and the data element having the value of “1” is shown by oblique lines.

The signal processor 610 selects one of a plurality of dithering data patterns depending on the values of the lower three bits of the compensated image data and the frame number with respect to the compensated image data of a specific pixel, and reads the values of data elements corresponding to the position of the pixel among the data elements of sixteen dithering data patterns. Based on the read values, the signal processor 610 determines the output image data DAT output to data driver 500.

In detail, when the value of the data element of the selected position is “0”, the data processor 610 determines the gray value determined by the upper eight bits of the compensated image signal as the final gray. However, when the value of the data element stored in the corresponding position is “1”, the data processor 610 determines a value obtained by adding “1” to the determined gray value of the upper eight bits as the final gray. Signal controller 600 outputs the image data DAT of eight bits corresponding to the final gray to data driver 500.

If the data pattern is not particularly determined when the value of the lower three bits is 000, the data processor 610 determines the gray value determined by the upper eight bits of the compensated image signal as the final gray in the case that the lower three bits of the compensated image signal are 000.

The dithering data pattern shown in FIG. 4 will now be explained in detail.

In the case that the lower three bits are 000, all the dithering data patterns of all frames have a value of “0”. In the case that the lower three bits are 001, all the dithering data patterns of the odd-numbered frames have a value of “0” and twelve elements among sixteen elements of the dithering data patterns of the even-numbered frames have a value of “0”, i.e., three data among every four data have a value of “0” and the other one has a value of “1”.

In the case that the lower three bits are 010, twelve elements among sixteen elements of the dithering data patterns of all the frames have a value of “0”, i.e., three data among every four data have a value of “0” and the other one has a value of “1”.

In the case that the lower three bits are 011, twelve elements among sixteen elements of the dithering data patterns of the odd-numbered frames have a value of “0”, i.e., three data among every four data have a value of “0” and the other one has a value of “1”, and eight elements among sixteen elements of the dithering data patterns of the even-numbered frames have a valued of “0”, i.e., two data among every four data have a value of “0” and the other two have a value of “1”.

In the case that the lower three bits are 100, eight elements among sixteen elements of the dithering data patterns of all the frames have a value of “0” , i.e., two data among every four data have a value of “0” and the other two have a value of “1”. In the case that the lower three bits are 101, eight elements among sixteen elements of the dithering data patterns of the odd-numbered frames have a value of “0”, i.e., two data among every four data have a value of “0” and the other two have a value of “1”, and four elements among sixteen elements of the dithering data patterns of the even-numbered frames have a valued of “0”, i.e., one data among every four data have a value of “0” and the other three have a value of “1”.

In the case that the lower three bits are 110, four elements among sixteen elements of the dithering data patterns of all the frames have a value of “0”, i.e., one data among every four data has a value of “0” and the other three have a value of “1”. In the case that the lower three bits are 111, all elements of the dithering data patterns of the even-numbered frames have a value of “1”, and four elements among sixteen elements of the dithering data patterns of the odd-numbered frames have a value of “0”, i.e., one data among every four data has a value of “0” and the other three have a value of “1”.

As such, in the eight frames, the numbers of elements among the sixteen elements of the dithering data pattern having “0” and “1” vary depending on the values of the lower three bits according to a rule of a principle of spatial dithering control.

One data element located at a given location with respect to each of the lower three bits has the numbers of the value of “0” or “1” depending on the values of the lower three bits, and this is determined by a rule of the temporal dithering control principle.

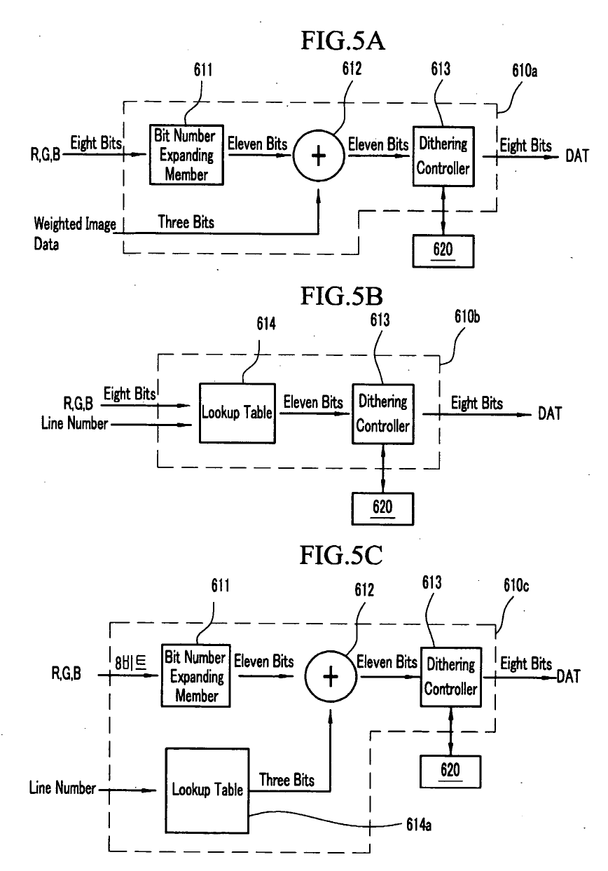

Next, a structure of the signal processor 610 for performing the data control as described above will be explained with reference to FIG. 5A to FIG. 5C.

FIG. 5A to FIG. 5C show examples of an inner block diagram of the signal processor of the signal controller of a liquid crystal display according to an exemplary embodiment of the present invention.

A signal processor 610a shown in FIG. 5A includes a bit number expanding member 611 to which input image signals R, G, and B are input, an adder 612 for adding the image signal from the bit number expanding member 611 and the weighted image signal of a weight value, and a dithering controller 613 connected to the compensated image signal from the adder 612 and the lookup table 620.

The number of bits of the input image signals R, G, and B is eight, and the number of bits of the weighted image signal is three. At this time, the value of the weighted image signal is predetermined depending on the respective line numbers of the gate line set, and is input to be synchronized with the input image signals R, G, and B.

The bit number expanding member 611 expands the input image signals R, G, and B of eight bits to a signal of eleven bits, and outputs the expanded signal to the adder 612. For example, if the input image signal is “00011011”, the bit number expanding member 611 adds data of “000” to lower bits so as to convert the same to “00011011000”, and outputs the converted data to the adder 612.

The adder 612 adds an imaginary image signal having a corresponding value to the expanded input image signal so as to generate the compensated image signal of eleven bits, and inputs the compensated image signal to the dithering controller 613. For example, in the case that the weighted image signal is “001”, the compensated image signal is “00011011001 (=00011011000+001)”.

The dithering controller 613 performs the dithering control of the eleven-bit compensated image signal on the basis of the value of the lower three bits and the dithering data pattern stored in the lookup table 620, and applies the eight-bit output image signal DAT to data driver 500.

A signal processor 610b shown in FIG. 5B is provided with the lookup table 614 to which the input image signals R, G, and B and the line number in a gate line set are input, instead of the bit number expanding member 611 and the adder 612.

The corresponding eleven-bit compensated image data determined as a finction of the eight-bit input image signals R, G, and B and the line number in the gate line set is stored in the lookup table 614. Accordingly, if the image signals R, G, and B and the line number in the gate line set corresponding to the input image signals R, G, and B are input, the lookup table 614 selects an eleven-bit compensated image data corresponding to this information among a plurality of pre-stored compensated image data, and inputs the selected data to the dithering controller 613. Accordingly, since the bit number expanding member 611 and the adder 612 need not to be designed, the data processing time is substantially decreased and the manufacturing cost is also decreased.

A signal processor 610c shown in FIG. 5C includes a gate line lookup table 614a to which the line number in the gate line set is input, in addition to the bit number expanding member 611, the adder 612, and the dithering controller 613 shown in FIG. 5A.

The lookup table 614a stores respective weighted image data corresponding to the line number.

Accordingly, rather than inputting the three-bit weighted image signal to the adder 612 in real time, the corresponding weighted image data corresponding to the line number is selected from the lookup table 614a, and the eleven-bit compensated image signal is generated by the operation of the adder 612. Then, the generated signal is input to the dithering controller 613.

In this case, since it is sufficient that only a three-bit weighted image signal is stored, the lookup table 614a shown in FIG. 5C is substantially smaller than the lookup table 614 shown in FIG. 5B.

The number of bits of the input image signal is eight in the present exemplary embodiment, but it is not limited thereto and can be varied.

In addition, although the number of lines of the gate line set is six in the present exemplary embodiment, it can be increased or decreased if necessary. As the number of lines of the gate line set decreases, a period of applying impulsive data becomes shorter, and thereby a frequency of the horizontal synchronization start signal STH and a frequency of the data clock signal HCLK increase.

According to the present invention, in the case that the impulsive data voltage is simultaneously applied to the pixel rows of a predetermined number so as to display impulsive image, a luminance difference generated by different normal image data display periods for respective lines of the gate line set can be compensated. Accordingly, picture quality of a display device is improved.

Furthermore, luminance poorness generated by different charging conditions between the first gate line of the gate line set and the other gate lines can be compensated by applying the impulsive data voltage, and thereby picture quality of a display device is improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus for a display device having a plurality of pixels, comprising:
a plurality of gate line sets connected to the pixels and transmitting a gate-on voltage to the pixels;
a plurality of data lines connected to the pixels and transmitting a normal data voltage and an impulsive data voltage thereto;
a signal controller converting input image data of a first gray to output image data of a second gray and outputting the converted data;
a data driver connected to the data line and applying the normal data voltage and the impulsive data voltage corresponding to the output image data to the data line; and
a gate driver connected to the gate line and applying the gate-on voltage to the gate line according to a control of the signal controller,
wherein the normal data voltage is sequentially applied to a first gate line set among the plurality of gate line sets, and
the impulsive data voltage is sequentially applied to a second gate line set among the plurality of gate line sets.

2. The driving apparatus of claim 1, wherein:
the input image data has a first number of bits; and
the signal controller adds weighted image data of a second number of bits to the input image data of the first number of bits so as to convert the input image data to compensated image data of a third number of bits.

3. The driving apparatus of claim 2, wherein the signal controller outputs the compensated image data as the output image data if the number of bits of the output image data is equal to the number of bits of the compensated image data.

4. The driving apparatus of claim 2, wherein if the bit number of bits of the output image data is different from the number of bits of the compensated image data, the signal controller stores a plurality of dithering data patterns comprised of data elements having a first value or a second value, selects the dithering data pattern corresponding to the compensated image data of the second number of bits among the plurality of dithering data patterns, converts the compensated image signal to an output image signal of a fourth number of bits that is less than the third number of bits on the basis of the selected dithering data pattern, and outputs the converted signal.

5. The driving apparatus of claim 4, wherein the signal controller comprises a first lookup table for storing a plurality of dithering data patterns and a data processor for converting the compensated image data on the basis of the plurality of dithering data patterns stored in the first lookup table.

6. The driving apparatus of claim 5, wherein the data processor comprises:
a bit number expanding member expanding the input image data of the first number of bits to the input image data of the third number of bits;
an adder adding the input image data of the third number of bits and the weighted image data of the second number of bits so as to generate the compensated image data of the third number of bits; and
a dithering controller converting the compensated image data of the third number of bits to the output image data of the fourth number of bits.

7. The driving apparatus of claim 5, wherein the data processor comprises:
a second lookup table storing a plurality of compensated image data of the third number of bits as a function of the input image data of the first number of bits and a line number of a first gate line set, and selecting the compensated image data of the third number of bits corresponding to the input image data and the line number and outputting the selected data; and
a dithering controller converting the compensated image data of the third number of bits to the output image data of the fourth number of bits.

8. The driving apparatus of claim 5, wherein the data processor comprises:
a bit number expanding member expanding the input image data of the first number of bits to the input image data of the third number of bits;
a second lookup table storing a plurality of weighted image data of the second number of bits corresponding to respective line numbers of a first gate line set, and selecting the weighted image data of the second number of bits corresponding to a line number of the first gate line set and outputting the selected data;
an adder adding the input image data of the third number of bits and the weighted image data of the second number of bits so as to generate the compensated image data of the third number of bits; and
a dithering controller converting the compensated image data of the third number of bits to the output image data of the fourth number of bits.

9. The driving apparatus of claim 4, wherein a difference between the third number of bits and the fourth number of bits is three.

10. The driving apparatus of claim 9, wherein the dithering data pattern corresponding to the compensated image data among the plurality of dithering data patterns is determined on the basis of three lower bits of the compensated image signal and a frame number.

11. The driving apparatus of claim 10, wherein the signal processor determines upper bits excluding the lower three bits as a data value of the output image data, if a value of the lower three bits of the compensated image data is 000.

12. The driving apparatus of claim 1, wherein the second gray is equal to or greater than the first gray.

13. The driving apparatus of claim 1, wherein a frequency of the input image data is different from a frequency of the output image data.

14. The driving apparatus of claim 13, wherein a frequency of the input image data is less than a frequency of the output image data.

15. The driving apparatus of claim 1, wherein the gate-on voltage comprises a first gate-on voltage applying the normal data voltage and a second gate-on voltage applying the impulsive data voltage.

16. The driving apparatus of claim 15, wherein applying periods of the first and second gate-on voltages are equal to each other.

17. The driving apparatus of claim 16, wherein the applying periods of the first and second gate-on voltages are shorter than 1H.

18. The driving apparatus of claim 1, wherein the impulsive data voltage is less than the normal data voltage.

19. The driving apparatus of claim 18, wherein the impulsive data voltage is a black data voltage.
